(19) United States
(12) Patent Application Publication
(10) Pub. No.: US 2013/0076832 A1
(43) Pub. Date: Mar. 28, 2013

(54) Liquid Ejecting Head

(71) Applicant: Seiko Epson Corporation, Tokyo (JP)

(72) Inventor: Tomohiro Sayama, Nagano-ken (JP)

(73) Assignee: SEIKO EPSON CORPORATION, Tokyo (JP)

(21) Appl. No.: 13/627,126

(22) Filed: Sep. 26, 2012

(30) Foreign Application Priority Data
Sep. 27, 2011 (JP) 2011-210328

(51) Int. Cl. B41J 2/135

(52) U.S. Cl. 347/47

(57) ABSTRACT

Disclosed herein is a liquid ejecting head is provided in which a plurality of pressure chambers is formed along a nozzle row direction where a plurality of pressure chambers is arranged in parallel with one another to be divided by each partition wall, and a change in pressure of a liquid in each of the pressure chambers is generated by driving of each pressure generation unit to allow the liquid to be ejected from each of the nozzles, wherein at least one of the pressure chambers located at opposite ends of the plural pressure chambers is a dummy pressure chamber from which the liquid is not ejected, and the dummy pressure chamber is filled with the liquid.

### CROSS-REFERENCE TO RELATED APPLICATION

The entire disclosure of Japanese Patent Application No. 2011-210328, filed Sep. 27, 2011 is expressly incorporated by reference herein.

### BACKGROUND

1. Technical Field

The present invention relates to a liquid ejecting head for an ink jet type recording apparatus or the like.

2. Related Art

As a liquid ejecting head which discharges droplets from a nozzle opening by causing a change in pressure of a liquid in a pressure chamber, there are, for example, an ink jet type recording head used for an image recording apparatus such as a printer, a color material ejecting head used to manufacture a color filter for a liquid crystal display or the like, an electrode material ejecting head used to form an electrode for an organic EL (Electro-Luminescent) display, an FED (Field Emission Display), or the like, a bio-organic substance ejecting head used to manufacture a biochip (biochemical device), and the like.

The above liquid ejecting head introduces the liquid from a liquid supply source to pressure chambers, causes the change in the pressure of the liquid in each of the pressure chambers, and ejects the liquid from each of nozzles using the change in the pressure. In such a liquid ejecting head, a plurality of nozzles is arranged at a high degree of density so as to correspond to an improvement in image quality of a recording image. Therefore, the pressure chambers, which are communicated with the respective nozzles, are also formed at a high degree of density, and a partition wall to divide the adjacent pressure chambers or passages other than the same tends to become much thinner. For this reason, when the change in the pressure of the liquid in the pressure chamber is caused and the liquid is ejected from the nozzle, a pressure loss is caused since the partition wall is bent toward the pressure chamber adjacent thereto by the change in the pressure. As a result, an amount of or flying speed of the liquid, which is ejected from the nozzle, is reduced from the target value.

Particularly, among the plural pressure chambers arranged in parallel with one another, opposite sides of each of the pressure chambers (that is, each of the pressure chambers except for the pressure chambers located at opposite ends in the parallel direction), which are located to the inside in the parallel direction, are respectively abutted against the other pressure chambers, with the partition walls being interposed between the respective opposite sides of each pressure chamber and the respective other pressure chambers, thereby resulting in a relatively large pressure loss. On the other hand, one side of each of the end pressure chambers, which are located at the opposite ends in the parallel direction, is abutted against the other pressure chamber, with the partition wall being interposed therebetween, whereas the other side of the end pressure chamber becomes a wall which is thicker than and has higher stiffness than the partition wall between the pressure chambers. Since the wall is difficult to be deformed even through the change in the pressure within the associated pressure chamber, a relatively low pressure loss is generated in the pressure chamber. As a result, among the plural pressure chambers arranged in parallel with one another, differences in the pressure loss are generated between the respective pressure chambers which are located to the inside and the respective pressure chambers which are located at the opposite ends, and irregularities are generated on an impacted target (recording medium) due to differences in the concentration of the liquid.

In this regard, it has been proposed that a dummy pressure chamber from which a liquid is not ejected is provided at an end of each of a plurality of pressure chambers arranged in parallel with one another (for example, see JP-A-2011-062937). Thereby, a change in pressure of the liquid in the pressure chamber which is located at the end is propagated to both of the pressure chamber and the dummy pressure chamber adjacent thereto, and a pressure loss generated in this case may be closer to the pressure chamber which is located to the inside.

However, the dummy pressure chamber of the above-mentioned liquid ejecting head of the related art is a space which is independent of the other pressure chambers or passages, and is filled with air. As the liquid and the air have different compression ratios from each other, when the change in the pressure is generated in the pressure chamber adjacent to the dummy pressure chamber, a partition wall of the dummy pressure chamber and another partition wall of the other pressure chamber side filled with the liquid have different deformation degrees from each other. Thus, a method of propagating the change in the pressure to the dummy pressure chamber differs from a method of propagating the change in the pressure to the pressure chamber side filled with the liquid. For this reason, it is difficult to reliably suppress variation of the pressure loss in each pressure chamber through simple provision of only the dummy pressure chamber. As a result, differences in liquid ejection characteristics (the amount of or flying speed of the liquid ejected from each nozzle) may be generated and irregularities may be generated on an impacted target due to differences in the concentration of the liquid.

### SUMMARY

An advantage of some aspects of the invention is to provide a liquid ejecting head capable of allowing each of a plurality of pressure chambers to have the same liquid ejection characteristics.

According to an aspect of the invention, a liquid ejecting head is provided in which a plurality of pressure chambers is formed along a nozzle row direction where a plurality of pressure chambers is arranged in parallel with one another to be divided by each partition wall, and a change in pressure of a liquid in each of the pressure chambers is generated by driving of each pressure generation unit to allow the liquid to be ejected from each of the nozzles, wherein at least one of the pressure chambers located at opposite ends of the plural pressure chambers is a dummy pressure chamber from which the liquid is not ejected, and the dummy pressure chamber is filled with the liquid.

According to the liquid ejecting head of the invention, the dummy pressure chamber is filled with the liquid in the same form as the other pressure chamber. Therefore, when the change in the pressure is generated in the pressure chamber adjacent to the dummy pressure chamber, a deformation degree of the partition wall of the dummy pressure chamber side may be adjusted to be equal to a deformation degree of the partition wall of the other pressure chamber side. Thereby, even in the pressure chamber adjacent to the dummy pressure chamber among the pressure chambers arranged in parallel, the amount of pressure loss of the pressure chamber (the amount of pressure loss when the change in the pressure of the same size is generated) may be attained to the same extent as the pressure loss of the other pressure chamber which is located to the inside. As a result, each of the pressure chambers arranged in parallel may have the same liquid ejection characteristics.

In the above configuration, the dummy pressure chamber may have a width, in a direction where the plural pressure chambers are arranged in parallel, equal to a width of the pressure chamber in the same direction.

According to such a configuration, the amount of pressure loss in the dummy pressure chamber side may be accurately adjusted by the amount of pressure loss in the pressure chamber side.

In each of the configurations, the partition wall to divide the dummy pressure chamber and the pressure chamber may have a width equal to a width of the other partition wall to divide the pressure chamber and another pressure chamber.

According to such a configuration, the amount of pressure loss in the dummy pressure chamber side may be further accurately adjusted by the amount of pressure loss in the pressure chamber side.

In addition, the liquid ejecting head may further include a reservoir to supply the plural pressure chambers with a common liquid, and the reservoir may be communicated with the dummy pressure chamber.

According to such a configuration, the liquid supplied to the dummy pressure chamber may be equal to the liquid supplied to the pressure chamber. The amount of pressure loss in the dummy pressure chamber side may be further accurately adjusted by the amount of pressure loss in the pressure chamber side.

Furthermore, the liquid ejecting head may further include a reservoir to supply the plural pressure chambers with a common liquid, and the dummy pressure chamber may be a space which is independent of the reservoir, and is filled with a liquid having a composition which is different from the liquid ejected from the nozzle.

According to such a configuration, it may be possible to prevent dust or bubbles from remaining in the dummy pressure chamber. Even in the case of using a liquid which contains particles, such as pigments, in the liquid ejected from the nozzle, it may be possible to prevent the particles from being settled and deposited in the dummy pressure chamber.

In each of the configurations, a compression ratio of the liquid filled in the dummy pressure chamber may be equal to a compression ratio of the liquid ejected from the nozzle.

According to such a configuration, the amount of pressure loss in the dummy pressure chamber side may be further accurately adjusted by the amount of pressure loss in the pressure chamber side.

### BRIEF DESCRIPTION OF THE DRAWINGS

The invention will be described with reference to the accompanying drawings, wherein like numbers reference like elements.

FIG. 1 is a perspective view illustrating a printer.

FIG. 2 is an exploded perspective view for explaining a configuration of a recording head.

FIG. 3 is a sectional view schematically illustrating a principal portion of a recording head according to a first embodiment.

FIG. 4 is a sectional view taken along line IV-IV of FIG. 3.

FIG. 5 is a sectional view schematically illustrating a principal portion of a recording head according to a second embodiment.

### DESCRIPTION OF EXEMPLARY EMBODIMENTS

Hereinafter, embodiments of the invention will be described with reference to the accompanying drawings. Although the embodiments described below are limited to various specific preferred embodiments of the invention, the scope of the invention is not limited thereto unless the invention is otherwise limited in the following description. Hereinafter, an ink jet type recording apparatus 1 (hereinafter, referred to as a printer), by way of example, will be described as a liquid ejecting apparatus of the invention.

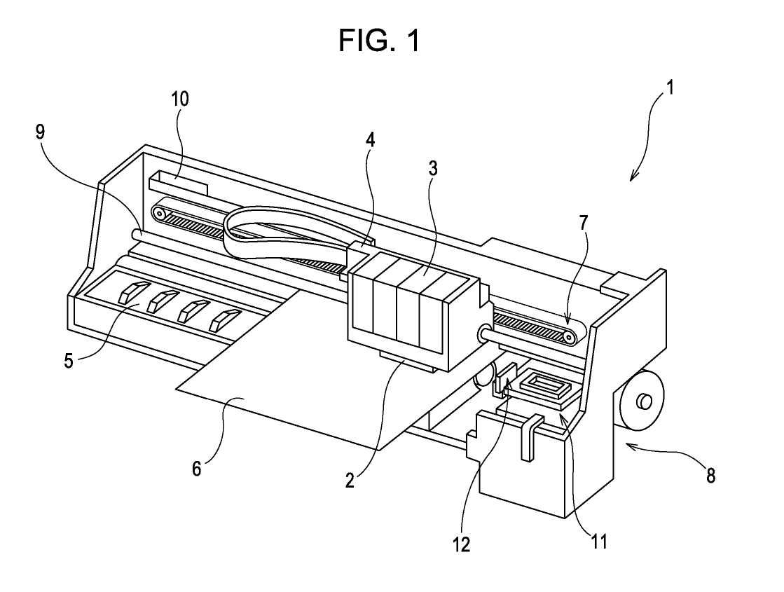

FIG. 1 is a perspective view illustrating a configuration of a printer 1. The printer 1 includes a carriage 4, to which a recording head 2 which is a kind of liquid ejecting head is mounted and an ink cartridge 3 which is a kind of liquid supply source is detachably mounted, a platen 5 which is arranged below the recording head 2 during a recording operation, a carriage moving mechanism 7 to reciprocate the carriage 4 in a paper width direction of, namely, in a main scanning direction of recording paper 6 (which is a kind of recording medium and impacted target), and a transport mechanism 8 to transport the recording paper in a sub-scanning direction perpendicular to the main scanning direction.

The carriage 4 is mounted in a state of being axis-supported by a guide rod 9 installed in the main scanning direction, and is moved along the guide rod 9 in the main scanning direction by an operation of the carriage moving mechanism 7. A linear encoder 10, which is a kind of position information detection unit, detects a position of the carriage 4 in the main scanning direction thereof, and transmits a detected position signal, namely, an encoder pulse (which is a kind of position information) to a controller of the printer 1.

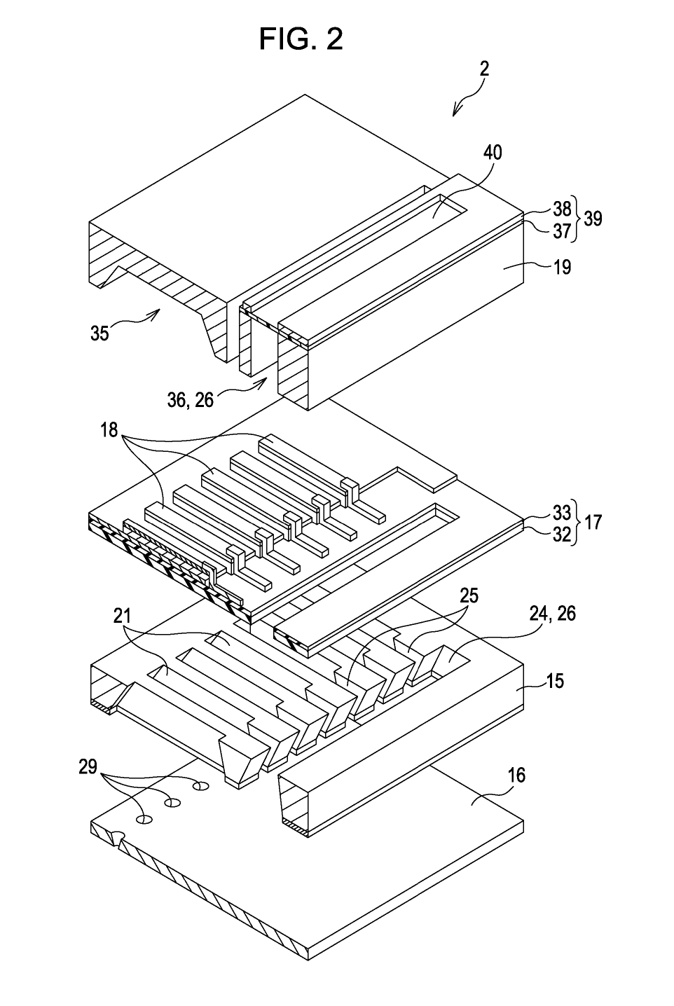

Also, a home position which is a starting point of scanning of the carriage 4 is set at an end region outside a recording region within a movement range of the carriage 4. In the embodiment, the home position is disposed with a capping member 11 to seal a nozzle forming surface (a nozzle plate 16: see FIGS. 2 and 4) of the recording head 2 and a wiper member 12 to sweep the nozzle forming surface. The printer 1 performs a so-called bi-directional recording process which records characters, images, or the like on the recording paper 6 by bi-directional movement of the carriage 4, that is forward movement in which the carriage 4 is moved from the home position toward an end side opposite to the home position and backward movement in which the carriage 4 is returned from the opposite end side to the home position.

Next, the recording head 2 will be described.

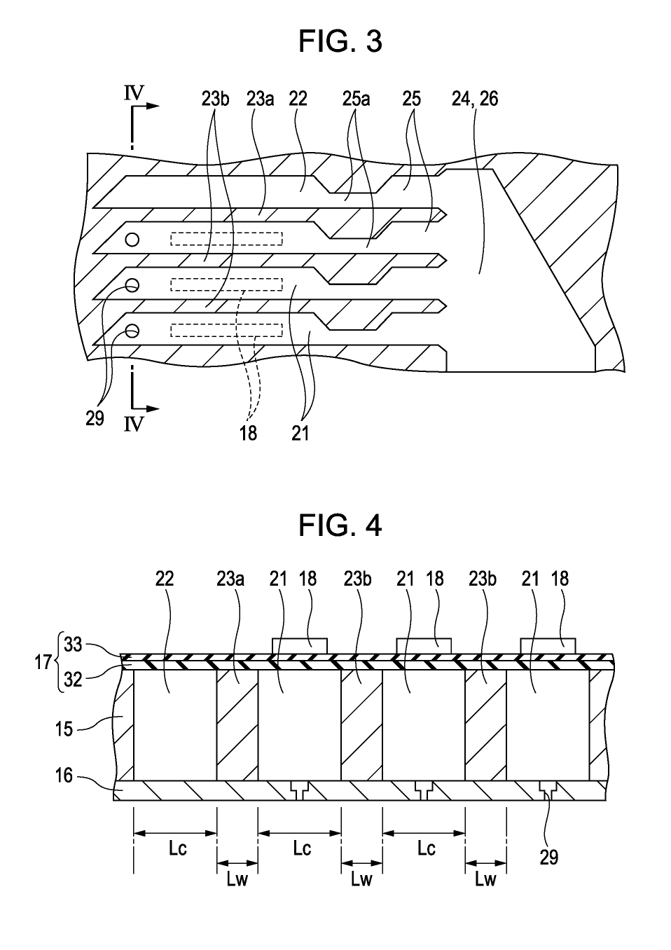

FIG. 2 is an exploded perspective view illustrating a configuration of the recording head 2 according to the embodiment. FIG. 3 is a sectional view schematically illustrating a principal portion of the recording head 2. FIG. 4 is a sectional view taken along line IV-IV of FIG. 3. The recording head 2 according to the embodiment includes a passage forming substrate 15, a nozzle plate 16, a vibration plate 17, piezoelectric devices 18 (corresponding to pressure generation units in the invention), a protective substrate 19, and the like, and these are configured to be laminated.

The passage forming substrate 15 of the embodiment is made of a silicon single crystal substrate. The passage forming substrate 15 is provided with a plurality of pressure chambers 21 in parallel with one another along a nozzle row direction to be described later. Each of the pressure chambers 21 is an empty section which is elongated in a direction perpendicular to a nozzle row. Dummy pressure chambers 22, from which a liquid is not ejected, are formed at end portions of the pressure chambers in a parallel direction of each thereof. In the embodiment, the dummy pressure chambers 22 are respectively formed at opposite ends of the plural pressure chambers in the parallel direction one by one. In other words, the pressure chambers, which are located at the opposite ends of the plural pressure chambers in the parallel direction, become the dummy pressure chambers 22. The pressure chambers 21 and the dummy pressure chambers 22 are sealed, at upper portions thereof, with the vibration plate 17 while being sealed, at lower portions thereof, with the nozzle plate 16, as will be described later. The pressure chambers 21 are communicated with nozzles 29, respectively. The piezoelectric devices 18 are arranged on the vibration plate 17 to correspond to the respective pressure chambers 21 (as will be described later).

Moreover, each of the dummy pressure chambers 22 in the embodiment is an empty section having the same dimensions and shape as each pressure chamber 21. For this reason, as shown in FIG. 4, the dummy pressure chamber 22 has a width Lc, in a direction where the plural pressure chambers are arranged in parallel, equal to a width Lc of the other pressure chamber 21 in the same direction. Also, a gap between the dummy pressure chamber 22 and the pressure chamber 21 adjacent thereto is equal to a gap between the other pressure chambers 21. That is, as shown in FIG. 4, a partition wall 23a to divide the dummy pressure chamber 22 and the pressure chamber 21 has a width Lw equal to a width Lw of a partition wall 23b to divide the pressure chambers 21.

An elongated communication portion 24 is formed in a row along the direction where the plural pressure chambers are arranged in parallel, at a region outside the pressure chambers 21 and the dummy pressure chambers 22 of the passage forming substrate 15 in a longitudinal direction of each thereof. The communication portion 24 is communicated with the pressure chambers 21 and the dummy pressure chambers 22 through respective ink supply passages 25. Thereby, each pressure chamber 21 and each dummy pressure chamber 22 are filled with an ink of the communication portion 24. Each of the ink supply passages 25 has a narrow width portion 25a, at a portion thereof, which is formed at a smaller width than the pressure chamber 21 and the dummy pressure chamber 22, thereby uniformly maintaining passage resistance of the ink which is introduced from the communication portion 24 to the pressure chamber 21. Moreover, the communication portion 24 is communicated with a common chamber 36 of the protective substrate 19 to be described later to constitute a portion of a reservoir 26 which becomes a common ink chamber of each pressure chamber 21.

The nozzle plate 16 which constitutes the bottom of each pressure chamber 21 is bonded to a side (lower side) of an opening surface of the passage forming substrate 15. The nozzle plate 16 is made of a silicon single crystal substrate, stainless steel, or the like, which has, for example, a thickness of approximately 0.1 to 1 mm, and is formed with a nozzle row composed of a plurality of nozzles 29. The nozzles 29 are communicated with end sides of the pressure chambers 21 opposite to the ink supply passages 25, respectively. Meanwhile, in the embodiment, the nozzles 29 are not formed at positions corresponding to the dummy pressure chambers 22. Furthermore, for example, the nozzles 29 are formed by etching when the nozzle plate 16 is made of a silicon single crystal substrate, and the nozzles 29 are formed by a press process or a laser process when the nozzle plate 16 is made of stainless steel.

The vibration plate 17 is formed at a side (upper side) opposite to the opening surface of the passage forming substrate 15. The vibration plate 17 of the embodiment includes, for example, an elastic film 32 which is made of silicon dioxide (SiO₂) of, for example, approximately 1.0 μm in thickness, and an insulating film 33 which is laminated on the elastic film 32 and made of zirconium oxide (ZrO₂) of, for example, approximately 0.4 μm in thickness. Also, the plural piezoelectric devices 18 are arranged on the insulating film 33 so as to correspond to the respective pressure chambers 21. In the embodiment, each of the piezoelectric devices 18 is a vibrator of a flexural vibration mode, and has a piezoelectric body which is interposed between a drive electrode and a common electrode (not shown). When a drive signal is applied to the drive electrode of the piezoelectric device 18, an electric field is generated between the drive electrode and the common electrode in response to a potential difference therebetween. When this electric field is applied to the piezoelectric body, the piezoelectric body is deformed in response to the strength of the applied electric field. Then, due to this deformation, the volume of the pressure chambers 21 is changed, and the pressure of the ink in the pressure chamber 21 is changed.

In addition, the protective substrate 19 is bonded to a surface of a piezoelectric device 18 side on the passage forming substrate 15 in a state of interposing the vibration plate 17 therebetween, and the protective substrate 19 has a piezoelectric device holding portion 35 which is a space having the size with no hindrance of displacement of the piezoelectric devices 18 in a region facing the same. The piezoelectric devices 18 are protected in a state of being nearly unaffected by the external environment since being housed in the piezoelectric device holding portion 35. Furthermore, as shown in FIG. 2, the protective substrate 19 is provided with the common chamber 36 at a region corresponding to the communication portion 24 of the passage forming substrate 15. The common chamber 36 penetrates the protective substrate 19 in a thickness direction thereof and is provided along a direction parallel to the pressure chambers 21. The common chamber 36 is communicated with the communication portion 24 of the passage forming substrate 15, as described above, thereby constituting the reservoir 26 which becomes the common ink chamber of each pressure chamber 21.

Furthermore, a compliance substrate 39 includes a sealing film 37 and a fixed plate 38, and is bonded on the protective substrate 19. The sealing film 37 is made of a flexible material (for example, a polyphenylene sulfide film of 6 μm in thickness), and one side surface of the common chamber 36 is sealed by the sealing film 37. Also, the fixed plate 38 is made of a hard material such as metal (for example, stainless steel of 30 μm in thickness). Since a region of the fixed plate 38 which faces the reservoir 26 becomes an opening portion 40 which is entirely removed in the thickness direction, one side surface of the reservoir 26 is sealed only by the sealing film 37 having flexibility.

In the recording head 2 having the above-mentioned configuration, the ink in the ink cartridge 3 is introduced from an ink introduction passage which is not shown, and is then supplied to each pressure chamber 21 and each dummy pressure chamber 22 through the reservoir 26. In a state of filing the ink in the pressure chamber 21 and the dummy pressure chamber 22, the piezoelectric device 18 corresponding to each pressure chamber 21 is driven by supply of a drive signal from a printer controller side which is not shown, thereby generating a change in pressure of the ink in each pressure chamber 21. As a result, ink droplets are ejected (discharged) from the associated nozzle 29 by controlling the generated change in the pressure.

Here, when the change in the pressure is generated by driving of the piezoelectric device 18, the change in the pressure is propagated through the partition wall 23 to the ink of the pressure chamber 21 side adjacent thereto or of the dummy pressure chamber 22 side adjacent thereto, and a pressure loss is generated. In detail, when the inner portion of the pressure chamber 21 is changed to negative pressure, the partition wall 23 is bent to an inner side (the associated pressure chamber 21 side). On the other hand, when the inner portion of the pressure chamber 21 is changed to positive pressure, the partition wall 23 is bent to an outer side (another pressure chamber 21 side adjacent to the pressure chamber 21 or the dummy pressure chamber 22 side adjacent thereto) while resisting pressure of the ink within another pressure chamber 21 adjacent to the pressure chamber 21 or the dummy pressure chamber 22 adjacent thereto. Thus, a portion of the change in the pressure generated within the pressure chamber 21 by driving of the piezoelectric device 18 is absorbed, and the pressure loss is generated. In this case, an amount of pressure loss depends on ease bending the partition wall 23 and a ratio of volume change (for example, a compression ratio) of the ink filled in the adjacent pressure chamber 21 or the adjacent dummy pressure chamber 22. That is, the amount of pressure loss is increased when the compression ratio of the ink is high or the partition wall 23 is apt to be easily bent. Whereas, the amount of pressure loss is decreased when the compression ratio of the ink is low or the partition wall 23 is difficult to be bent. As the pressure loss is increased, the ejection characteristic of the ink (an amount of or flying speed of the ink which is ejected from the nozzle 29) which is ejected from the nozzle 29 is reduced from the target value.

In the embodiment, the dummy pressure chamber 22 is filled with the ink, similarly as the other pressure chamber 21, that is, the dummy pressure chamber 22 is filled with a liquid. Therefore, when the change in the pressure is generated in the pressure chamber 21 adjacent to the dummy pressure chamber 22, a deformation degree of the partition wall 23 of the dummy pressure chamber 22 side may be adjusted to be equal to a deformation degree of the partition wall 23 of the other pressure chamber 21 side. Accordingly, the amount of pressure loss by propagation of the change in the pressure may be adjusted to be equal between the dummy pressure chamber 22 side and the pressure chamber 21 side. Thereby, even in the pressure chamber 21 adjacent to the dummy pressure chamber 22 among the pressure chambers 21 arranged in parallel, the pressure loss of the pressure chamber 21 may be attained to the same extent as the pressure loss of the other pressure chamber 21 which is located to the inside. As a result, each of the pressure chambers 21 arranged in parallel may have the same liquid ejection characteristics.

In addition, in the embodiment, since the width Lc of the dummy pressure chamber 22 in the direction where the plural pressure chambers are arranged in parallel is equal to the width Lc of the pressure chamber 21 in the same direction, the amount of pressure loss in the dummy pressure chamber 22 may be accurately adjusted by the amount of pressure loss in the pressure chamber 21. Furthermore, since the width Lw of the partition wall 23a to divide the dummy pressure chamber 22 and the pressure chamber 21 is equal to the width Lw of the partition wall 23b to divide the pressure chambers 21, the amount of pressure loss in the dummy pressure chamber 22 may be further accurately adjusted by the amount of pressure loss in the pressure chamber 21. In addition, since the reservoir 26 is communicated with the dummy pressure chamber 22, the liquid supplied to the dummy pressure chamber 22 may be equal to the liquid supplied to the pressure chamber 21. Accordingly, the amount of pressure loss in the dummy pressure chamber 22 may be further accurately adjusted by the amount of pressure loss in the pressure chamber 21.

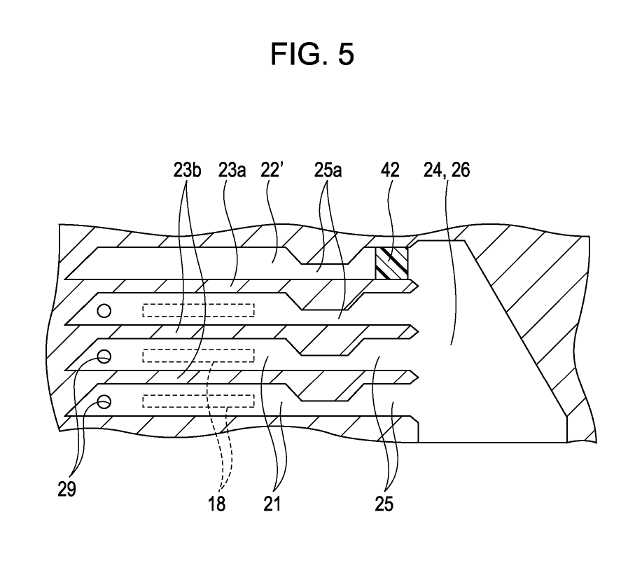

Although the above embodiment has been described as communicating the reservoir 26 and the dummy pressure chambers 22, the invention is not limited thereto. For example, in a second embodiment shown in FIG. 5, each of dummy pressure chambers 22′ is a space which is independent of the reservoir 26, and is filled with a liquid having a composition which is different from the ink (ink within the reservoir 26) ejected from the associated nozzle 29 in the dummy pressure chambers 22′.

Specifically, a portion of an ink supply passage 25′ communicated with the dummy pressure chamber 22′ is filled with a sealing material 42 which is made of an adhesive, a resin, or the like, and the ink supply passage 25′ is sealed. Accordingly, the dummy pressure chamber 22′ is isolated from the reservoir 26. The dummy pressure chamber 22′ is filled with the liquid, which has the composition different from the ink ejected from the nozzle 29 and is equal to the compression ratio of the ink, wherein the liquid is, for example, a liquid (namely, a solvent of an ink) which extracts colored components such as pigments or dyes from the ink. In addition, such a dummy pressure chamber 22′ is formed in such a way that a portion of the ink supply passage 25′ is first sealed by the sealing material 42 in a state of bonding the vibration plate 17 to the passage forming substrate 15, in this state, the dummy pressure chamber 22′ is filled with the liquid, and then the nozzle plate 16 is bonded to the passage forming substrate 15. Also, since the other configurations are the same as the first embodiment, the description thereof will be omitted.

As such, in the embodiment, since the dummy pressure chamber 22′ is a space which is independent of the reservoir 26, it may be possible to prevent dust or bubbles from remaining in the dummy pressure chamber 22′. Also, the dummy pressure chamber 22′ is filled with the liquid having the component which is different from the ink ejected from the nozzle 29. Therefore, even in the case of using a liquid which contains particles, such as pigments, in the liquid ejected from the nozzle 29, it may be possible to prevent the particles from being settled and deposited in the dummy pressure chamber 22′. Furthermore, since the compression ratio of the liquid filled in the dummy pressure chamber 22′ is equal to the compression ratio of the ink ejected from the nozzle 29, the amount of pressure loss in the dummy pressure chamber 22′ may be accurately adjusted by the amount of pressure loss in the pressure chamber 21.

Here, the invention is not limited to the above-mentioned embodiments, but various modifications may be possible based on the following claims. For example, although each embodiment has been described as locating the dummy pressure chambers 22 at opposite ends in the direction where the plural pressure chambers are arranged in parallel, the dummy pressure chamber 22 may also be provided at one end of the opposite ends. In addition, although the second embodiment has been described as using the sealing material 42, the dummy pressure chamber 22′ may also be made of a space which is independent of the reservoir 26 without using the sealing material 42. For example, when the passage forming substrate 15 is made by etching or the like, the dummy pressure chamber 22′ may also be formed by (not communicating with the reservoir 26) leaving a portion corresponding to the sealing material 42 in the ink supply passage 25 in advance.

In addition, the liquid ejected from the liquid ejecting head of the embodiment is not particularly limited, and, for example, it may also be a liquid using an organic solvent as a solvent. The liquid using the organic solvent as the solvent has a higher compression ratio than a water-based liquid, and the amount of pressure loss is large in the configuration of the related art. However, since the amount of pressure loss in the dummy pressure chamber 22′ may be adjusted by application of the embodiments, liquid ejection characteristics may be adjusted.

Moreover, in the above-mentioned embodiments, although the so-called flexural vibration type piezoelectric vibrator has been exemplified as the pressure generation unit, the invention is not limited thereto. For example, the invention may adopt a so-called vertical vibration type piezoelectric vibrator. Furthermore, the invention may be applied even when various pressure generation units, such as a heating device to generate bubbles in a pressure chamber and an electrostatic actuator to change a capacity of the pressure chamber using an electrostatic force, are utilized, in addition to the piezoelectric vibrator as the pressure generation unit.

The invention is not limited to the printer, but may also be applied to various ink jet type recording apparatuses such as a plotter, a facsimile apparatus, and a copy machine, or liquid ejecting heads which are used for liquid ejecting apparatuses such as a display manufacturing apparatus, an electrode manufacturing apparatus, and a chip manufacturing apparatus, other than the recording apparatuses, as long as the liquid ejecting heads of the liquid ejecting apparatuses are able to control the ejection of liquids using the pressure generation unit. In the display manufacturing apparatus, solutions of color materials of R (Red), G (Green), and B (Blue) are ejected from a color material ejecting head. Also, in the electrode manufacturing apparatus, a liquid-phase electrode material is ejected from an electrode material ejecting head. Furthermore, in the chip manufacturing apparatus, a solution of a bio-organic substance is ejected from a bio-organic substance ejecting head.

What is claimed is:

1. A liquid ejecting head in which a plurality of pressure chambers is formed along a nozzle row direction where a plurality of pressure chambers is arranged in parallel with one another to be divided by each partition wall, and a change in pressure of a liquid in each of the pressure chambers is generated by driving of each pressure generation unit to allow the liquid to be ejected from each of the nozzles,
wherein at least one of the pressure chambers located at opposite ends of the plural pressure chambers is a dummy pressure chamber from which the liquid is not ejected, and
wherein the dummy pressure chamber is filled with the liquid.

2. The liquid ejecting head according to claim 1,
wherein the dummy pressure chamber has a width, in a direction where the plural pressure chambers are arranged in parallel, equal to a width of the pressure chamber in the same direction.

3. The liquid ejecting head according to claim 1,
wherein the partition wall to divide the dummy pressure chamber and the pressure chamber has a width equal to a width of the other partition wall to divide the pressure chamber and another pressure chamber.

4. The liquid ejecting head according to claim 1, further comprising:
a reservoir to supply the plural pressure chambers with a common liquid,
wherein the reservoir is communicated with the dummy pressure chamber.

5. The liquid ejecting head according to claim 1, further comprising:
a reservoir to supply the plural pressure chambers with a common liquid,
wherein the dummy pressure chamber is a space which is independent of the reservoir, and is filled with a liquid having a composition which is different from the liquid ejected from the nozzle.

6. The liquid ejecting head according to claim 5,
wherein a compression ratio of the liquid filled in the dummy pressure chamber is equal to a compression ratio of the liquid ejected from the nozzle.
